(19) United States
(12) Patent Application Publication
(10) Pub. No.: US 2017/0335887 A9
(43) Pub. Date: Nov. 23, 2017

(54) SEALING ASSEMBLY FOR A ROLLING BEARING

(71) Applicant: IMO Holding GmbH, Gremsdorf (DE)

(72) Inventors: Erich Russ, Gremsdorf (DE); Hubertus Frank, Hochstadt (DE)

(21) Appl. No.: 15/215,063

(22) Filed: Jul. 20, 2016

Related U.S. Application Data
(63) Continuation-in-part of application No. 13/642,991, filed on Oct. 23, 2012, now abandoned.

(30) Foreign Application Priority Data
Apr. 23, 2010 (DE) 10 2010 018 255.9

(51) Int. Cl. F16C 19/38

(52) U.S. Cl. CPC F16C 19/381

(57) ABSTRACT

The invention relates to a sealing assembly for a rolling bearing having two mutually concentric rings spaced apart from each other by a fully circumferential gap in which one or more rows of revolving rolling elements are disposed, such that the two rings are rotatable relative to each other about their common axis, wherein the gap is sealed in the region of at least one of its two mouths, and wherein provided in the region of a gap seal are at least two seal rings, each having at least one sealing lip and an anchoring region on a surface region of the particular seal ring that faces away from the sealing lip, the seal rings being fixed to the same rolling bearing ring, whereas their respective sealing lips bear against the other rolling bearing ring, specifically against surface regions having identical or similar cross section.

### REFERENCE TO PENDING PRIOR PATENT APPLICATION

This patent application is a continuation-in-part of U.S. patent application Ser. No. 13/642,991, filed Oct. 23, 2012, which is a 371 of International (PCT) Patent Application No. PCT/EP2011/002077, filed Apr. 26, 2011, which in turn claims benefit of German Patent Application No. 10 2010 018 255.9, filed Apr. 23, 2010, which patent applications are hereby incorporated herein by reference.

### FIELD OF THE INVENTION

The invention relates to a sealing assembly for a rotary joint, particularly for a rolling bearing comprising two mutually concentric rings spaced apart from each other by a circumferential gap in which one or more rows of revolving rolling elements are disposed, such that the two rings are rotatable relative to each other about their common axis, and wherein the gap is sealed in the region of at least one of its two mouths.

### BACKGROUND OF THE INVENTION

The field of application for rotary joints in general, and for rolling bearings in particular, is boundless. Rotary joints of the type of the invention, particularly rolling bearings, are commonly lubricated with grease, less often with oil. The lubricant is retained in the region of the (rolling) bearing by seals, preferably disposed on both sides. The seals are frequently in the form of individual shaft seal rings, which are fixed with additional retaining rings, or are pressed directly together with the adjacent structure by means of the fastening screws.

In wind power installations, in particular, bearings of this kind are used increasingly as rotor bearings. This design is often preferred especially in gearless wind power installations, since it is economical and space-saving.

Due to the compact construction of wind power installations, it is not always possible to replace these seal rings once they are installed. To effect a replacement, it is often necessary to dismantle the generator or the hub, with the blades. The associated disassembly and downtime costs are extremely high. Costs are likely to be especially high for wind power installations situated in hard-to-access areas or actually offshore, i.e., out on the ocean far from the coast, where specialized vessels are needed for such work.

In addition, this often very poor accessibility makes it difficult to estimate and evaluate the condition of a seal. Since a rotor bearing of this kind, which can easily weigh several tons, still is, or will be, connected to the generator, and perhaps to other parts of the adjacent structure, the possibility cannot always be ruled out that dirt may get into the vicinity of the seal, for example, in the course of installation, maintenance or repair work, with consequent damage to the sealing lip and thus impairment of the overall sealing effect.

US 2010/0247295 A1 discloses a two-row tapered roller bearing with an outer ring and two inner rings. The inner rings are disposed in an axial direction and abut each other. Between the outer ring and the inner rings is a gap. A flange or nose extends from the outer ring into the gap, and both inner rings have a recess that accommodate the flange of the outer ring without any direct contact. In the area between inner and outer rings are two rows of rollers. A retaining ring at each end face of the outer ring retains one sealing ring. This sealing ring is not in contact with the outer ring itself, but is only held by the regarding retaining ring. Such retaining ring is formed from two rings which are removable from each other to insert or remove a seal ring. Nowhere is a sealing ring overlapped at its outer side from the retaining ring itself, but the retaining ring operates as a seat for the seal ring to which the seal ring is pressed by a third and flat, outermost ring, which itself is screwed to the retaining ring. Due to such arrangement, the inner side of the innermost sealing ring is not flush with the inner end face of the retaining ring which is in contact with the regarding raceway ring. Therefore, such arrangement is rather complicated. Additionally, only one seal ring is used at each end face of the bearing, so that in case of leakage of this single bearing, the leaked lubricant is entirely lost.

DE 10 2007 049 087 A1 discloses a roller bearing with a double sealing ring at each end face of the bearing. Only at the first embodiment of this document are the sealing rings anchored at the nose ring. There is no retaining ring with a substantially L-shaped cross section which overlaps the sealing rings with a planar flank. Furthermore, the inner side of the innermost sealing ring is not flush with the inner end face of the retaining ring which is in contact with the regarding raceway ring.

JP S63 312 512 A discloses a combined cylindrical roller bearing. At this document, too, nowhere is an inner side of an innermost sealing ring flush with an inner end face of a retaining ring which itself would be in contact with the regarding raceway ring. Therefore, the structure of this bearing is rather complicated, too.

The disadvantages of the prior art give rise to the problem initiating the invention, that of improving a sealing assembly of the aforesaid kind in such a way that the sealing effect is optimal, insofar as possible, the most important point being to ensure higher reliability even under challenging environmental conditions. In addition, maintenance should be made easier, and, where practicable, it should also be possible to replace a seal of this kind without having to remove the particular bearing or parts thereof.

### SUMMARY OF THE INVENTION

This problem is solved by the fact that provided in the region of a gap seal are at least two spaced-apart seal rings, each having at least one sealing lip and an anchoring portion on a surface region of the particular seal ring that faces away from the sealing lip, wherein the seal rings are fixed by their anchoring portions to a common portion of the same rolling bearing ring, whereas their respective sealing lips bear against the other rolling bearing ring, specifically against thrust surfaces produced together with at least one raceway of the particular rolling bearing ring by machining or shaping a common base body, wherein the cross-sectional shapes of the thrust surfaces for the sealing lips of adjacent seal rings are identical or similar and are not separated from each other by either a bend or a step.

By virtue of the mutually corresponding surface regions, a plurality of such seal rings can be used and can be installed and even replaced, if necessary, in a simple manner. This is because the seal ring, disposed deeper inside the bearing gap, can readily be pushed away over the thrust surface of the outer seal ring without any risk of damage. In this context, the phrase “similar cross sections” is intended to refer to the basic geometry of the particular thrust surface, i.e., either both thrust surfaces are cylindrical or hollow-cylindrical, or they are both conical or planar. Irrespective of this overall geometry, a curvature can still be present transverse to the particular thrust surface; but this will be described in more detail later on below. The fact that the cross-sectional shapes of the thrust surfaces for the sealing lips of adjacent seal rings are not separated from each other by a bend or a step makes it much easier to put in place or insert one or both seal rings. A rolling bearing sealed according to the invention can even be operated in the open air without additional jacketing and will still always be protected adequately against inclement weather.

Particular advantages are provided by a design improvement according to which the anchoring regions of two adjacent seal rings are received in a common depression of a rolling bearing ring, particularly in a common recess or groove. Such a common depression is easier to produce than several mutually separate grooves; the seal rings can also be inserted in it more easily.

In this connection, the assembly can be configured such that a receiving portion that is part of a rolling bearing ring and contains the common depression, particularly recess or groove, is detachable from the main portion of the particular bearing ring. This has the particular advantage that to release a seal ring, a bearing portion at least locally surrounding it is first removed to make the seal itself easier to access. Such a detachable portion of a bearing ring can optionally be configured as one-piece, that is, as a closed, i.e. double-connected, ring, which can be pulled off or at least displaced, only in the axial direction in order to get at the seals, or it can be a part composed of plural segments, of which none of the individual segments completely surrounds the axis of rotation. In such case, these segments can not only be displaced in the axial direction but can also be moved in the radial direction, for example removed completely, without any need to dismantle the bearing ring concerned. In both embodiments, a specialized geometry can be provided in the region of the parting joint between the main portion of the particular bearing ring and the portion detachable from it, to automatically center the detachable portion as it is being mounted. This can be for example, a fully circumferential step or recess on one portion, the mating counterpart being formed on the respective other portion.

It is within the scope of the invention that the common depression, particularly groove or recess, is disposed on an annular receiving portion which itself has no raceway of any kind, but is fixed to an annular main portion of the particular rolling bearing ring that does have at least one raceway, produced by machining or shaping a common base body. This affords the possibility of gaining access to the seal rings concerned without having to expose the rolling elements.

The invention affords the further possibility that the receiving portion detachable from the main portion of a rolling bearing ring consists of a different, or a differently treated, material from the main portion of that rolling bearing ring. It should be kept in mind, here, that to provide adequate service life, the main portion of the particular ring, comprising the bearing raceways, is preferably made from an expensive, particularly hard, or at least hardenable, bearing material, for example, a special steel. Such a requirement normally does not apply to the detachable ring portion, which only has to hold the seal rings. Consequently, to reduce the cost of such a rotary joint, another material can be used for this purpose, for example, brass, and/or in any case the material concerned is not put through a hardening step, as in the case of unhardened steel.

The invention recommends that the receiving portion detachable from the main portion of a rolling bearing ring has an approximately L-shaped cross section, whose end face facing toward the rolling elements is smaller in area than its end face facing away from the rolling elements. A ring with an L-shaped geometry makes it possible not only to center the particular seal rings in the radial direction, but also simultaneously to clamp them in place in the axial direction. Easy release is made possible by the fact that the end face, that is smaller in area, is facing toward the rolling elements and can thus be pulled off over the seal rings, if necessary.

The invention can be improved in that the receiving portion detachable from the main portion of a rolling bearing ring has, in the region of its end face facing away from the rolling elements, a circular-disk-shaped portion that overlaps the end face of one seal ring. This larger end face of the cross-sectionally L-shaped receiving ring has the function of pressing the overlapped seal ring and additional seal rings immediately adjacent thereto firmly against a portion of the end face of the rolling bearing ring comprising the raceways for the rolling elements.

The anchoring regions of two adjacent seal rings should be spatially separated from each other, so that the chamber between them has the greatest possible volume and can therefore provide sufficient receiving space for any leaking lubricant before it reaches the outer seal ring.

The feature just described can be realized in a particularly simple manner by separating the anchoring regions of two adjacent seal rings from each other by one or more spacers disposed between them. Such spacers make for particularly stable positioning of the seal rings they separate, and can also absorb axial pressure, so the anchoring regions of the seal rings can be additionally clamped in place.

Although the spacers can also be connected to the particular bearing ring, i.e., for example, in the form of bars protruding from the surface regions concerned, it is nevertheless provided, in continuation of the above inventive idea, that at least one spacer is configured as a ring or ring segment. These are detachable parts that can be replaced as necessary, or even exchanged, for parts having another geometry, in the event that sealing rings of another geometry are to be used for the adjacent seals. In particular, ring segments can also subsequently be inserted in groove-shaped depressions in concave surface regions of a bearing ring.

It is further provided that the sealing lips of adjacent seal rings bear against the same rolling bearing ring in spaced relation. Their distance apart is preferably constant along the entire circumference. If a seal ring extends along a plane that is intersected perpendicularly by the axis of rotation of the particular rotary joint, the sealing lip slides only in its longitudinal direction along the particular thrust surface, thus keeping friction to a minimum. In such case, the distance between two adjacent sealing lips should also be measured parallel to the axis of rotation of the particular rotary joint. This distance between the two sealing lips results in the creation of a chamber between the two sealing rings. This chamber serves to receive whatever quantity of lubricant has escaped the inner seal ring. Since any such leakage from the inner seal ring takes place relatively slowly if at all, the chamber fills with lubricant only gradually, and the outer seal ring can therefore retain the lubricant completely for a relatively long period of time.

The invention can be further improved in that between two seal rings, at least one conduit, preferably a bore, opens into the common depression or between the two thrust surface regions for the sealing lips of adjacent seal rings. In such case, this conduit can, for example, be used to check the fill level of the chamber between the two seal rings to determine whether any action is needed, for example, the addition of more lubricant or replacement of the seal. In addition, the possibility also exists—specifically in the case of oil as the lubricant—of using such a conduit to recycle lubricant that has found its way from the inner seal ring back into the gap region, such recycling, for example, taking place automatically under the force of gravity or being performed manually as a maintenance procedure. So that the lubricant cannot, conversely, make its way back through this conduit from the interior of the gap past the inner seal and into the chamber, such a conduit (or each such conduit) can be fitted with a check valve that permits flow only in the direction from the chamber between two seal rings to the interior of the gap, and blocks flow under reverse pressure conditions.

Two adjacent seal rings should both be integrated in such a way that an internal overpressure from the middle of the gap toward its mouth presses the sealing lip additionally against its thrust surface. Such a measure permits and assists the complete filling of the bearing gap with lubricant, an operation that might occasionally give rise to a local overpressure; this does not result in leakage, however, but presses the sealing lip particularly firmly against the thrust surface until the local overpressure has declined due to internal compensatory movement of the lubricant.

A preferred embodiment of the invention is distinguished by the fact that the rear anchoring region of a seal ring is substantially thicker in a direction running parallel to the cross section of the thrust surface than the portion of the seal ring adjacent the sealing lip. The function of such a thickened anchoring region is to give the seal ring adequate stability, whereas the front sealing lip is particularly elastic so that it is always able to conform to the thrust surface even if the bearing deforms severely, for example under the influence of external forces and/or moments, particularly tilting moments.

This purpose is also served by an improvement according to which the sealing lip of a seal ring is disposed at the free edge of an approximately collar-like, preferably conical, portion of the seal ring. This collar-like portion preferably has a smaller thickness and thus a higher elasticity than the thickened anchoring region and thus enables the sealing lip to move—within certain limits—relative to the anchoring region.

A seal ring according to the invention can be integrated in such a way that the collar-like portion of the seal ring does not extend, in cross section, perpendicular to the particular thrust surface, but rather in closer proximity to the outer, unsealed region of the thrust surface. This results in a cross-sectional shape, particularly on the respective inner face of the sealing ring—i.e., the surface facing the interior of the particular gap—which is parallel, or at least approximately parallel, to the particular thrust surface, and which can absorb the internal lubricant pressure and thereby presses the particular sealing collar, including the sealing lip located thereon, against the particular thrust surface.

The collar-like portion of a seal ring is preferably connected to its anchoring portion, specifically in that region of the end face of the anchoring portion which is located outside the sealed gap region. This one-piece embodiment is geometrically optimized and combines utmost stability with optimal sealing action.

It is, further, within the scope of the invention that at least one seal ring comprises a tensioning means, for example, a fully circumferential tension wire, to press the particular sealing lip firmly against the particular thrust surface. In this way, the contact pressure of a sealing lip against its thrust surface can be further increased, in order to enhance the sealing action still more where necessary. Such a tension wire can, for example, be coiled into a helical spring that passes once around the particular seal ring.

Such a fully circumferential tension spring should have a length that is equal to, or greater than, the diameter of a rolling element, multiplied by the number of rolling elements in the row concerned. Such dimensioning ensures that the tension spring produces the highest possible pressing force without being overstretched, instead remaining within the elastic deflection range.

It has proven beneficial for two adjacent seal rings to have the same cross-sectional structure. The seal rings used could—despite their identical structure—still have different cross-sectional dimensions or dimensional ratios. It is nevertheless recommended that two adjacent seal rings be identical. If an optimal cross-sectional geometry is found, then it can be used for both or all of the seal rings.

It is within the scope of the invention that the cross-sectional shapes of the thrust surfaces for the sealing lips of adjacent seal rings have mutually corresponding transverse curvatures, i.e., that they each have a concave transverse curvature or a convex transverse curvature, or that they each have a flat, i.e. planar, transverse profile with no transverse curvature whatsoever. Such an at least structurally identical transverse curvature—even if the radius of transverse curvature changes—also facilitates the insertion of the seal rings.

Further advantages are obtained if the cross-sectional shapes of the thrust surfaces for the sealing lips of adjacent seal rings have the same axial inclination, particularly are in mutual axial alignment. This feature is also intended to make the handling of the seal ring(s) as problem-free as possible.

Since the sealing lips of two adjacent seal rings bear or thrust against a common cylindrical surface region having a constant diameter, the seal rings need not be stretched or otherwise deformed during insertion and thus are not at risk of being damaged.

Finally, it is within the teaching of the invention that an outer seal is provided with a dust lip. The risk of ingress of dust or other particles can be effectively countered in this way. The element in question can be an additional seal ring, which may have a different cross section from the other seal rings of the particular gap seal.

Additional features, details, advantages and effects based on the invention will emerge from the following description of a preferred embodiment of the invention and by reference to the drawings.

### BRIEF DESCRIPTION OF THE DRAWINGS

FIG. 1 is a section through a first embodiment of a rolling bearing provided with a seal according to the invention;

FIG. 2 is an enlargement of detail II of FIG. 1;

FIG. 3 is an enlargement of detail III of FIG. 2;

FIG. 4 is section along line IV-IV in FIGS. 1 and 2;

FIG. 5 is an enlargement of detail V of FIG. 4;

FIG. 6 is a section through a second embodiment of a rolling bearing provided with a seal according to the invention; and

FIG. 7 is an enlargement of detail VII of FIG. 6.

### DETAILED DESCRIPTION OF THE INVENTION

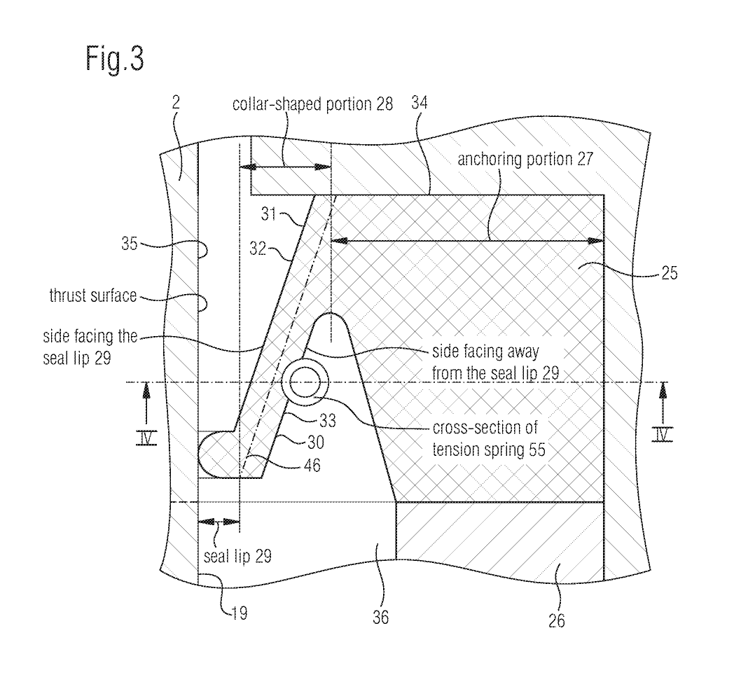

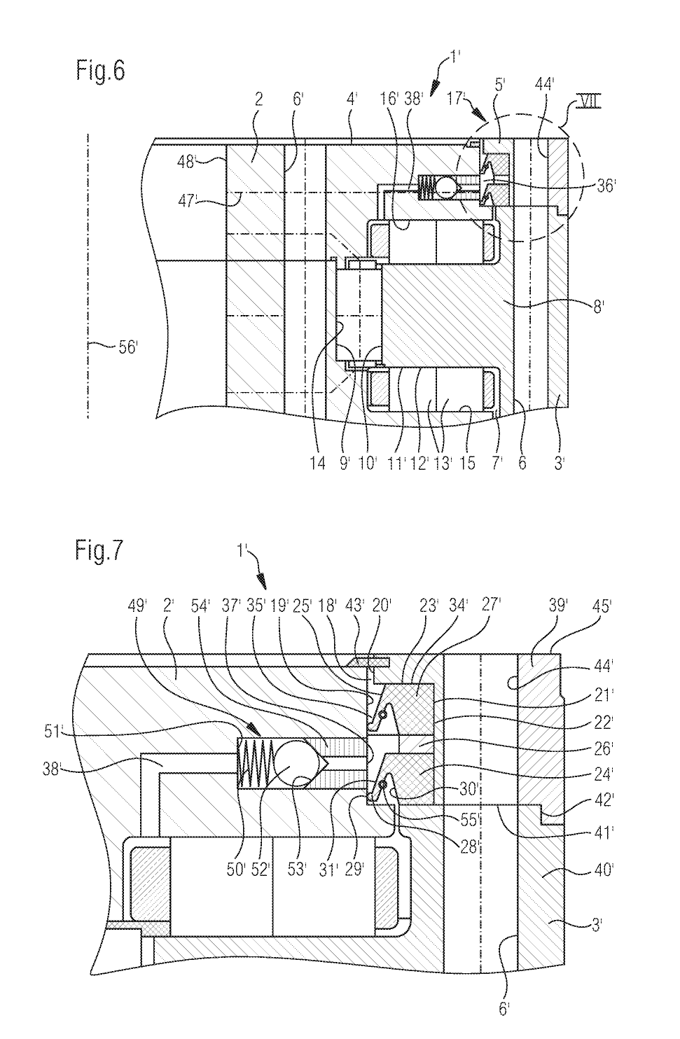

The drawings illustrate preferred embodiments of the sealing principle according to the invention. FIGS. 1 to 5 refer to a first embodiment of the invention, FIGS. 6 and 7 to a second embodiment of the invention.

In the drawings, the reference numerals 1 and 1′, respectively, denote rolling bearings that are preferably intended for use in a wind power installation, particularly as a rotor bearing or main bearing. Reference numerals without an apostrophe refer to the first embodiment of the invention, as illustrated in FIGS. 1 to 5, reference numerals with an apostrophe refer to similar pieces of the second embodiment of the invention, as illustrated in FIGS. 6 and 7.

Apparent in the drawings are two mutually concentric bearing rings, an inner ring 2 or 2′, respectively, of planar, circular shape and, engaged around the outside thereof, an outer ring 3 or 3′, respectively, of corresponding geometry. Each of the two rings 2, 3; 2′, 3′ preferably has planar end faces 4, 5, or 4′, 5′, respectively, which can serve as connection surfaces for connection to a foundation or to an installation part or machine part. Provided for this purpose, in at least one end face 4, 5; 4′, 5′ per bearing ring 2, 3; 2′, 3′, is a plurality of coronally arranged fastening means, particularly fastening bores 6 or 6′, respectively, whose longitudinal axes preferably extend perpendicularly to the respective end face 4, 5; 4′, 5′, and which are intended for machine screws, (threaded) bolts or the like to be passed through or screwed into them.

A gap 7 or 7′, respectively, is present between the two bearing rings 2, 3; 2′, 3′, so that the rings 2, 3; 2′, 3′ can rotate relative to each other. However, as is apparent from FIGS. 1 and 6, this gap 7; 7′ does not have a rectilinear cross section, but a shape having a plurality of bends.

The reason for this is that a fully circumferential flange 8 or 8′, respectively, preferably of approximately rectangular cross section, is disposed on a lateral side of one ring 2, 3; 2′, 3′ facing to the gap 7, 7′. For example, the flange 8; 8′ can be disposed at the inner side of outer ring 3, as illustrated in FIGS. 1 and 6. In technical jargon, such a flange 8; 8′ is termed a nose, and the ring concerned—here, outer ring 3—is known as a nose ring.

At the same time, the other ring—that one without a flange 8; 8′ or a nose, here, inner ring 2 —comprises a similarly shaped, fully circumferential depression 9 or 9′, respectively, with a larger cross section than the flange 8; 8′ or nose, such that the latter can in large part be received by the fully circumferential depression 9; 9′.

At the edges in the region of the free end face 10 or 10′, respectively, of the flange 8; 8′ or nose, as well as in the recesses at the base of the latter, the gap 7; 7′ bends approximately 90° in cross section in each case.

The free end face 10; 10′ of the flange 8; 8′, as well as its two flanks 11; 11′, each serve as raceways 12 or 12′, respectively for the roller-shaped rolling elements 13 or 13′, respectively. The counterparts to these raceways 12; 12′ are disposed at the bottom 14 or 14′, respectively, and at the two flanks 15 or 15′, respectively, of the depression 9; 9′ of inner ring 2; 2′, and are in the form of raceways 16 or 16′ there. These raceways 16; 16′ are preferably hardened, preferably by surface hardening.

Such rollers 13; 13′ are able to absorb or transfer extremely high forces and tilting moments and achieve much higher values in this regard than balls, for example, since they form linear rather than punctiform contact regions with the raceways 12, 16; 12′, 16′. For them to roll freely, however, the rolling elements 13; 13′ must be well lubricated, preferably with grease; only in relatively rare cases, lubricating oil is used for this purpose.

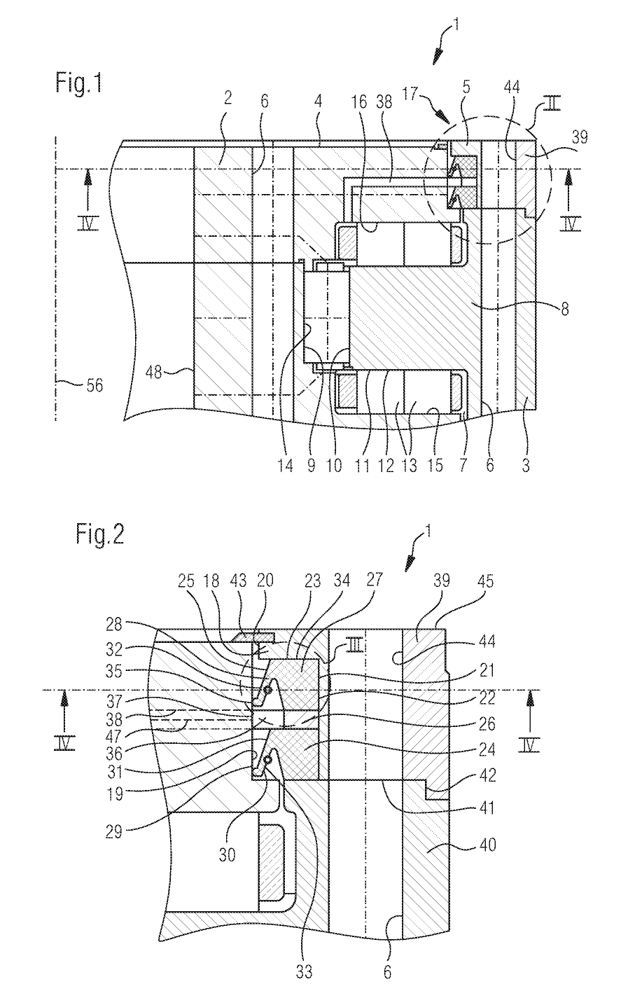

This lubricant must be durably retained in the region of the rolling elements 13; 13′, i.e., in the interior of the gap 7; 7′. This function is performed by seals 17 or 17′, respectively, in the region of the two end-face mouths 18 or 18′, respectively of the gap 7; 7′. In the example illustrated, the same seals 17; 17′ are used at both mouths 18; 18′, so only one of the two need be described. The details of the seals 17; 17′ are shown enlarged in FIGS. 2, 3 and 7, respectively, and thus are easier to see in those drawings.

In a mouth portion 18; 18′ of the gap 7; 7′, the outer side 19 or 19′, respectively, of the inner ring 2; 2′ follows a cylindrical shape. Opposite thereto, machined into the inner side 20 or 20′, respectively, of the outer ring 3; 3′ is a groove-shaped depression 21 or 21′, respectively, preferably having a hollow-cylindrical base 22 or 22′, respectively, and two planar flanks 23 or 23′, respectively, such that the cross section can be described by a rectangle.

Inserted in this depression 21; 21′ are two seal rings 24, 25 or 24′, 25′, respectively, and an also ring-shaped spacer element 26 or 26′, respectively, specifically one after the other in the axial direction parallel to the axis of rotation of the rolling bearing 1; 1′, the spacer element 26; 26′ being disposed between the two seal rings 24, 25; 24′, 25′.

As can be seen in FIGS. 2 and 6, in the illustrated exemplary embodiment the two seal rings 24, 25; 24′, 25′ are preferably identical. In such preferred embodiments, the two therefore have identical cross sections, each comprising three portions, specifically an anchoring portion 27 or 27′, respectively, a collar-shaped portion 28 or 28′, respectively, connected thereto and a sealing lip 29 or 29′, respectively, extending along the free edge of the collar-shaped portion 28; 28′.

It will be appreciated that, as a result of this cross-sectional geometry, a ring with a rectangular cross section will be provided with two incuts that extend along the its entire length. A first incut 30 or 30′, respectively, separates the anchoring portion 27; 27′, on the one side, from the collar-shaped portion 28; 28′ and the sealing lip 29; 29′, on the other side. This incut 30; 30′ has an approximately V-shaped cross section, with a depth that is only slightly smaller than the thickness, parallel to the bearing axis, of the particular seal ring 24, 25; 24′, 25′. Since the incut 30; 30′ is not in the middle of the sealing ring 24, 25; 24′, 25′, but is shifted towards the sealing lip 29; 29′, the anchoring portion 27; 27′ takes up roughly half the cross section of the originally rectangular ring cross section. Immediately adjacent incut 30; 30′—facing away from the anchoring portion 27; 27′—the collar-shaped portion 28; 28′ terminates in the sealing lip 29; 29′.

A second incut 31 or 31′, respectively, is on the opposite surface of the collar-shaped portion 28; 28′. It has only about half the cross section of the first incut 30; 30′, and it follows approximately the geometry of a right triangle whose hypotenuse 32 is approximately parallel to the nearest flank 33 of the first, V-shaped incut 30; 30′. The distance between this hypotenuse 32 and the nearest flank 33 of the first, V-shaped incut 30; 30′ corresponds to the thickness of the collar-shaped sealing portion 28; 28′.

Both seal rings 24, 25; 24′, 25′ are placed in the depression 21; 21′ in such a way that the collar-shaped portions 28; 28′ are each joined, in the region of a peripheral end face 34; 34′ of the respective seal ring 24, 25; 24′, 25′, to the anchoring portion 27; 27′ thereof, while the collar-shaped regions 28; 28′ extend from there along an oblique line 46 to the interior of the gap 7; 7′, thus the sealing lip 29; 29′ then sits, bearing against a cylindrical surface region 35; 35′ of the inner ring 2; 2′, which region serves as a thrust surface. Owing to the incut 30; 30′ that faces the gap interior 7; 7′ and widens in a V shape from the root of the collar-shaped region 28; 28′ near anchoring portion 27; 27′ on out to the sealing lip 29; 29′, an internal overpressure in the region of the gap interior 7; 7′ causes an increased pressure on the collar-shaped portion 28; 28′ in the region of the incut 30; 30′, thereby creating a force that presses the collar-shaped portion 28; 28′, and thus its sealing lip 29; 29′, toward the thrust surface 35; 35′, so hardly any lubricant is able to escape.

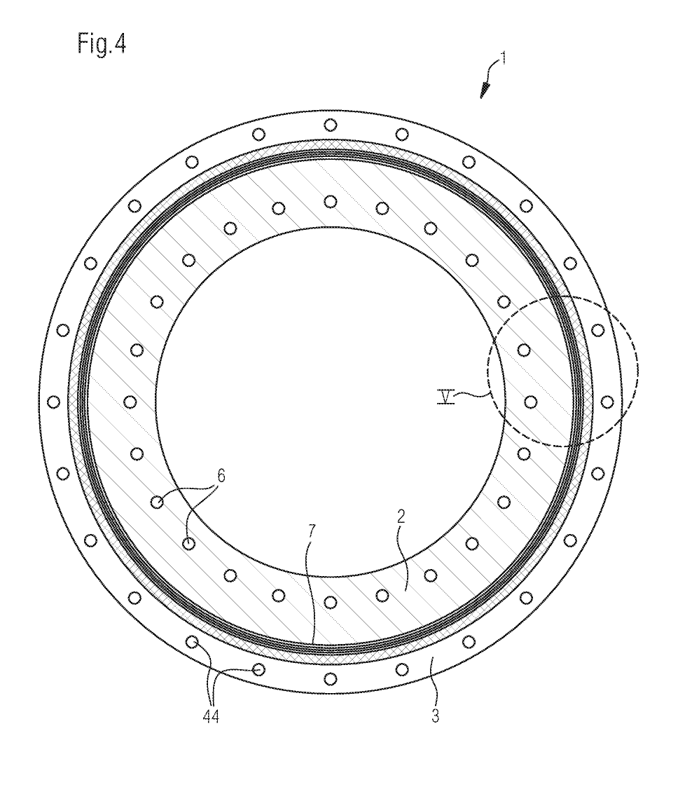

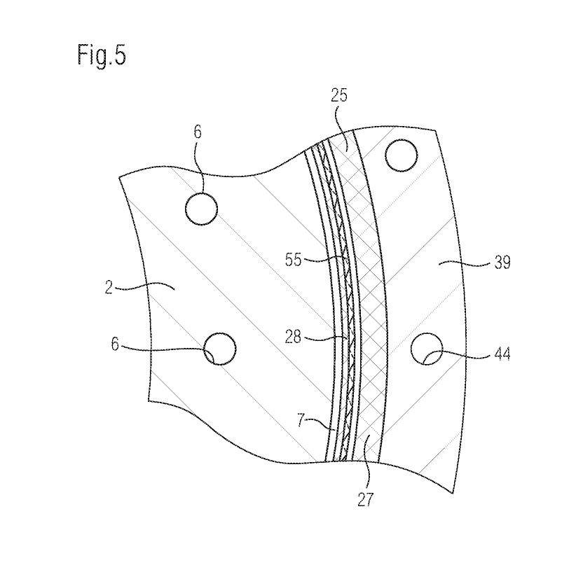

This pressing force can be further increased by using a spring 55 or 55′, respectively, that runs along the side of the collar-shaped portion 28; 28′ facing away from the sealing lip 29; 29′ and is pretensioned. From FIGS. 4 and 5 it can be seen that the spring 55; 55′ extends along the entire longitudinal circumference of the regarding sealing ring 24, 25; 24′, 25′, completely around the axis of rotation 56 or 56′, respectively, of the bearing 1; 1′. The spring 55; 55′ is seated inside the first incut 30; 30′ and is in engagement with the adjacent flank 33 of the collar-shaped portion 28; 28′ of the sealing ring 24, 25; 24′, 25′, to press the collar-shaped portion 28; 28′ in a radial direction inwardly towards the axis of rotation 56; 56′; thereby pressing the sealing lip 29; 29′ firmly and tightly against the regarding thrust surface 35; 35′.

To accommodate the spring 55; 55′ at a predetermined place along the oblique flank 33 of the collar-shaped portion 28; 28′, that flank 33 of the collar-shaped portion 28; 28′ may be equipped with an indentation extending completely around the axis of rotation 56; 56′. The concave cross-section of such indentation may be the pendant to the convex cross-section of the spring 55; 55′ so that the latter matches into the indentation.

The spring 55; 55′ may comprise a tension wire made of metal. Due to its length, such tension wire will have a limited elastic behaviour and can be pretensioned. The spring 55; 55′ can have different geometries:

First, it is possible to use a straight tension wire, running along the indentation in the flank 33. the ends of such straight tension wire may be equipped with matching threads so that by drilling the ends of such a tension wire its ends may be screwed into each other to pretension it. Such spring 55; 55′ may have less elasticity, but stronger force.

On the other hand, the spring 55, 55′ may have the form of a helical coil bent from a tension wire like a coil spring. Such spring 55; 55′ may have more elasticity, but less force.

Due to such measures, the sealing rings 24, 25; 24′, 25′ will be as tight as possible and for a long time no leakage of lubricant will occur. Nevertheless, even if the inner sealing ring 24; 24′ begins to leak, the lubricant will get no farther than a chamber 36; 36′ formed between the surface region 35; 35′, on the one hand, and the two seal rings 24, 25; 24′, 25′ and spacer element 26; 26′, on the other. Spacer element 26; 26′ serves to enlarge the chamber 36; 36′. Either it can consist of a single piece having an annular geometry, which either can be configured as a double-connected ring, or could be configured with a slit according to the fashion of a spring-lock washer, i.e., only single-connected, to make it easier to insert in, or to remove it from, the depression 21; 21′. Or, the spacer element 26; 26′ consists of a plurality of parts that mate together into a ring shape, i.e., for example, a plurality of ring-segment-shaped parts. The spacer ring 26; 26′, as a whole, preferably has a rectangular cross section; its radial extent preferably corresponds approximately to the relevant radial extent of the anchoring portion 27; 27′ of one seal ring 24, 25; 24′, 25′. Thereby, the cross section of the spacer ring 26; 26′ is of minimal extent, and its volume is minimal, too. Due to this, the volume of the chamber 36; 36′ has a maximum and is able to receive a maximum amount of leaked lubricant.

The spacer element 26; 26′ is preferably pressed against the bottom of the depression 21; 21′, so that the collar-shaped region 28; 28′, and particularly the sealing lip 29; 29′, can move without being hindered by it.

If some of the lubricant manages to escape from the inner seal ring 24; 24′, it first passes into the region of the chamber 36; 36′ and can be received by it. Only if the chamber 36; 36′ is full, some lubricant will come to be present at the outer seal ring 25; 25′. There is, consequently, a very long period of time during which the seal 17; 17′, as a whole, remains tight even though the inner seal ring 24; 24′ is already leaking.

So that this condition can be detected promptly, it is further provided according to the invention that a surface region located between the two thrust surfaces 35; 35′ and bounding the chamber 36; 36′ comprises at least one opening 37; 37′ to a conduit 38; 38′ through which the interior of the chamber 36; 36′ is accessible.

This conduit 38; 38′ can, for example, extend in a straight line 47; 47′ up to the outside of the bearing 1; 1′, for example up to a lateral surface 48; 48′ of the regarding ring 2, 3; 2′, 3′ facing away from the gap 7; 7′. On the other hand, such conduit 38; 38′ could extend along a turn or angle, to the nearest end face 4, 5; 4′, 5′ of the regarding ring 2, 3; 2′, 3′.

Such a mouth of the conduit 38, 38′ opening at an outer surface of the bearing 1; 1′ may be sealable, for example, by means of a plug, especially by a removable plug. During maintenance, such plug can be removed and the thus-obtained access to the chamber 36; 36′ can be utilized to determine whether the inner seal ring 24; 24′ is already leaking, hence whether or not countermeasures are necessary. The possibility also exists of routing the conduit 38; 38′- or a branch thereof—to the inner region of the gap 7; 7′ and having it open thereinto, so lubricant can be routed from the chamber 36; 36′ back to the gap interior 7; 7′, for example, under the effect of gravity. Such embodiment is shown in FIGS. 1 to 5.

To prevent lubricant from escaping through such a conduit 38′ in the opposite direction, from the gap 7′ into the chamber 36′, the conduit 38′ can, for example, be fitted with a check valve 49′ that closes when there is an overpressure from the gap interior 7′ to the chamber 36′ and opens only under reverse pressure conditions. Such embodiment is shown in FIGS. 6 and 7.

Such check valve 49′ may comprise a spring 50′, especially a coil spring or a helical spring incorporated in a radial extension of the conduit 38′ and abutting against a circular contact surface 51′ at a stepped broadening of the conduit 38′. The other end of the spring 50′ is elastically pressed against a valve body, especially against a spherical valve body 52′.

Under such pressing force of the spring 50′, the valve body 52′ is pressed against a valve seat 53′. According to FIG. 7, the valve seat 53′ can be a concave cone-shaped end face of a sleeve 54′, which can be inserted into a cross-sectionally enlarged region of the conduit 38′ near the mouth 37′ thereof facing the gap 7′. Preferably, such region of enlarged cross section extends from the mouth 37′ of the conduit 38′ up to the contact surface 51′ for the spring 50′.

Preferably, the conduit 38′ can have a cylindrical lateral surface, and—at least partially—this cylindrical lateral surface can comprise a hollow thread. If a pendant to such hollow thread is provided at the convex lateral surface of the sleeve 54′, the sleeve 54′ can be screwed from the side of the mouth 37′ into the conduit 38′ and thereby will be fixed there. By screwing it deeper or less deep into the conduit 38′, the spring 50′ will be compressed more or less and therefore will exert a stronger or weaker force on the valve body 52′. Therefore, the threshold level, where the valve body 52′ can be released from the valve set 53′, can be adjusted.

Thereby at the determined threshold level, the check valve 49′ will open to the inside of the gap 7′ and lubricant entrapped in the chamber 36′ will be able to return into the inner portion of the gap 7′, namely on the inner side of the inner sealing ring 24′.

It can also be seen in FIGS. 2 and 7 that a portion 39 or 39′, respectively, of that ring 2, 3; 2′, 3′ which does not comprise the thrust surface 35; 35′—in the disclosed embodiments the outer ring 3; 3′—comprising the depression 21; 21′ is separate from its main or middle portion 40; 40′ comprising the nose-shaped flange 8; 8′. The separation surface is constituted by a parting plane 41; 41′ extending parallel to the main plane of the bearing and having a fully circumferentially extending step 42; 42′ that serves as a centering aid during assembly.

Further to be observed in the drawing is that the ring portion 39; 39′ that contains the depression 21; 21′ and is detachable from the main or middle portion 40; 40′ of the particular ring—here, outer ring 3; 3′—is provided with coronally distributed bores 44 or 44′, respectively; penetrating the ring 39; 39′ in the direction parallel to the axis of rotation of the bearing. Fastening screws can be passed through these coronally distributed bores 44; 44′ to secure the particular ring 2, 3; 2′, 3′ to a machine, installation part, chassis, foundation or the like. The respective planar connection surface of rings 2, 3; 2′, 3′ is formed by the same free end face 45 or 45′, respectively, of detachable ring portion 39; 39′ that is penetrated by the bores 44; 44′. To allow the fastening screws to pass through, the axis-parallel bores 44; 44′ in detachable ring portion 39; 39′ are each aligned with a respective bore 6; 6′ in the main or middle portion 40; 40′ of the particular ring 2, 3; 2′, 3′.

According to FIGS. 1, 2, 6 and 7, the main ring portion 40; 40′ of the nose ring 3; 3′ comprising the flange 8; 8′ extends in an axial direction up to a plane 41; 41′ completely beyond the axially outermost raceway 16; 16′ of the ring 2; 2′ which comprises the thrust surfaces 35; 35′. There, the main ring portion 40; 40′ and the detachable ring portion 39; 39′ are in contact with each other.

Due to such structure, the cross section of the main ring portion 40; 40′ is such that the flanks 11; 11′ of the flange 8; 8′ are planar and are parallel to the partitioning plane 41; 41′. Furthermore, this planar flanks 11; 11′ are entirely on this side of the partitioning plane 41; 41′ and have a distance to the partitioning plane 41; 41′ of at least the diameter of the rollers 13; 13′ rolling along these flanks 11; 11′.

Therefore, the flange 8; 8′ of the nose ring 3; 3′ is machined from the same part or annular workpiece as the surface of the main ring portion 40; 40′ at the partitioning plane 41; 41′. Especially, a flange 8; 8′ with rectangular cross section of the nose ring 3; 3′ is machined from the same part or annular workpiece as the surface of the main ring portion 40; 40′ at the partitioning plane 41; 41′, which itself extends beyond all rollers 13; 13′.

Especially, the main ring portion 40; 40′ comprises no recess or indentation for insertion of a sealing ring 24, 25; 24′, 25′, but at the same time is in contact with the innermost of at least two sealing rings 24, 25; 24′, 25′. This is achieved in that the only indentation is completely machined into the detachable ring portion 39; 39′.

So, according to the present invention, the seal 17 consisting of two sealing rings 24, 25; 24′, 25′ is clamped between a planar portion of the surface of the main ring portion 40; 40′ and an indentation 21; 21′ of the detachable ring portion 39; 39′, which receives all sealing rings 24, 25; 24′, 25′ and perhaps a spacer 26; 26′ axially inserted between both sealing rings 24, 25; 24′, 25′.

Preferably, the bearing 1; 1′ is symmetrical to a middle plane of the bearing 1; 1′ which is intersected by the axis of rotation 56; 56′ in a rectangular manner.

The outer end face 45; 45′ of the detachable ring portion 39; 39′ covers the entire planar surface of the parting plane 41; 41′ between the main ring portion 40; 40′ and the detachable ring portion 39; 39′. Especially, at least one lateral surface of the detachable ring portion 39; 39′ is flush with the regarding lateral surface of the main ring portion 40; 40′. Even more special, the lateral surfaces of the main ring portion 40; 40′ and the detachable ring portion 39; 39′ facing away from the gap 7; 7′ are flush with each other.

All bores 6; 6′ of the nose ring 3; 3′ are placed in an area of the nose ring 3; 3′ which extends in an axial direction up to the parting plane 41; 41′ between the main ring portion 40; 40′ and the detachable ring portion 39; 39′. Thereby, all bores 6; 6′ of the nose ring 3; 3′ for fastening the nose ring 3; 3′ to a foundation, or to a chassis, or to an installation part, or to a machine part, regardless of into which end face of the nose ring 3; 3′ they open—whether they open into the end face 5; 5′ where the seal 17 is disposed, or they open into the opposite end face of the nose ring 3; 3′, or into both end faces of the nose ring 3; 3′, are disposed at such a radius from the axis of rotation 56; 56′ that their longitudinal axis penetrates the parting plane 41; 41′ between the main ring portion 40; 40′ and the detachable ring portion 39; 39′.

Due to such arrangement, there are no fastening bores 6; 6′ of the main ring portion 40; 40′ directly open to the surface of the bearing 1; 1′, at least at the side of the seal 17 according to the present invention; instead, there are fastening bores 44; 44′ in the detachable ring portion 39; 39′ which are open to the surface of the bearing 1; 1′; and all fastening bores at an end face of the bearing which is sealed by a seal 17 extend through the detachable ring portion 39; 39′ there.

Preferably, fastening bores 44; 44′ in the detachable ring portion 39; 39′ and their aligned bores 6; 6′ in the main ring portion 40; 40′ are through bores so that the channels each formed by at least one bore 44; 44′ and one bore 6; 6′ penetrate the regarding bearing ring 3; 3′ from one end face to the other.

These bores 44; 44′ penetrate the detachable ring portion 39: 39′ at its longest axial extension, so that the depression 21; 21′ in the detachable ring portion 39; 39′ has no contact to any bore 6; 6′ of the regarding detachable ring portion 39; 39′. Therefore, the depression 21; 21′ in the detachable ring portion 39; 39′ is vacant to receive at least two seal rings 24, 25; 24′, 25′ from which one is directly pressed against the surface of the main ring portion 40; 40′ at the parting plane 41; 41′. One plane surface of the anchoring portion 27; 27′ of that seal ring 24, 25; 24′, 25′ which is pressed directly onto the parting plane 41; 41′ of the main ring portion 40; 40′, is aligned with that plane surface of the detachable ring portion 39; 39′, which is in direct contact with the main ring portion 40; 40′ at the parting plane 41; 41′. Therefore, these aligned surfaces of the anchoring portion 27; 27′ of the regarding seal ring 24, 25; 24′, 25′ and the abutting surface of the detachable ring portion 39; 39′ are at the same time in direct contact with the surface of the main ring portion 40; 40′ at the parting plane 41; 41′.

Furthermore, the surface of the main ring portion 40; 40′ at the parting plane 41; 41′, against which the detachable ring portion 39; 39′ and the at least one seal ring 24; 24′ is pressed, is machined into the same body as the raceways 10, 12 at the flange 8; 8′ of the nose ring 3: 3′. Especially, the surface of the main ring portion 40; 40′ at the parting plane 41; 41′, against which the detachable ring portion 39; 39′ and the at least one seal ring 24; 24′ is pressed, is machined into the same body as the planar raceways 12 at the flanks 11 of the flange 8; 8′ of the nose ring 3: 3′.

For these reasons, the inner sealing ring 24; 24′ is in direct contact with at least three rings of the bearing 1; 1′, namely (i) with the main ring portion 40; 40′, to which one planar end face of the anchoring portion 27; 27′ abuts, (ii) with the detachable ring portion 39; 39′, to which one lateral surface of the anchoring portion 27; 27′ abuts, and (iii) with another ring 2; 2′ of the bearing 1; 1′ which comprises the thrust surfaces 35; 35′, where the sealing lip 29; 29′ abuts. According to the preferred embodiments, another element to which the inner sealing ring 24; 24′ preferably abuts, is a spacer 26; 26′ between the inner and outer seal ring 24, 25; 24′, 25′.

On the other hand, the outer sealing ring 25; 25′ is in direct contact with only two rings of the bearing 1; 1′, namely (i) with the detachable ring portion 39; 39′, to which one planar end face and one lateral surface of the anchoring portion 27; 27′ abuts, and (ii) with the other ring 2; 2′ of the bearing 1; 1′ which comprises the thrust surfaces 35; 35′, where the sealing lip 29; 29′ abuts. According to the preferred embodiments, another element to which the outer sealing ring 25; 25′ preferably abuts, is a spacer 26; 26′ between the inner and outer seal ring 24, 25; 24′, 25′.

Another important feature of the invention is that one lateral surface of the spacer 26; 26′ which is disposed in an axial direction between two seal rings 24, 25; 24′, 25′ of one seal 17; 17′, is flush with the lateral surfaces of the anchoring portions 27; 27′ of the two seal rings 24, 25; 24′, 25′ which abut against that spacer 26; 26′. Therefore, the lateral surface of the indentation 21; 21′ of the detachable ring portion 39; 39′ is neither interrupted nor recessed nor even stepped at the plane of the spacer 26; 26; instead, that parts of the lateral surface of the detachable ring portion 39; 39′ at the inner side of the indentation 21; 21′, which are on this side of the spacer 26; 26′ and beyond that spacer 26; 26′, are flush with each other and are machined from the same basic body part.

The depression 21; 21′, and thus the seal rings 24, 25; 24′, 25′ received therein, are disposed in the radial direction between the bores 44; 44 in detachable ring portion 39; 39′ that are aligned with the bores 6; 6′ of the main ring portion 40; 40′, and the bores 6; 6′ in that cylindrical region of the other ring—here, inner ring 2; 2′—which comprises the thrust surfaces 35; 35′.

There exists a possibility of disposing an additional dust seal at the outer seal ring 25; 25′, particularly in the region of incut 31; 31′ there, to prevent the ingress of dust or other particles into the region of the seal 17. This can be achieved by a third, external seal 43 or 43′, respectively, which is anchored in the lateral inner side 20; 20′ of outer ring 3; 3′ outside of second seal ring 25; 25′, and extends in part over the front face or connection surface 4; 4′, of inner ring 2; 2′ and there seals as dust-tightly as possible.

List of Reference Numerals

| | |
|---|---|
| 1 | Rolling bearing |
| 2 | Inner ring |
| 3 | Outer ring |
| 4 | End face |
| 5 | End face |
| 6 | Fastening bore |
| 7 | Gap |
| 8 | Flange |
| 9 | Depression |
| 10 | Free end face |
| 11 | Flank |
| 12 | Raceway |
| 13 | Rolling element |
| 14 | Bottom |
| 15 | Flank |
| 16 | Raceway |
| 17 | Seal |
| 18 | Mouth |
| 19 | Outer side |
| 20 | Inner side |
| 21 | Depression |
| 22 | Base |
| 23 | Flank |
| 24 | First seal ring |
| 25 | Second seal ring |
| 26 | Spacer element |
| 27 | Anchoring portion |
| 28 | Collar-shaped portion |
| 29 | Sealing lip |
| 30 | Incut |
| 31 | Incut |
| 32 | Hypotenuse |
| 33 | Flank |
| 34 | End face |
| 35 | Surface region |
| 36 | Chamber |
| 37 | Opening |
| 38 | Conduit |
| 39 | Detachable portion |
| 40 | Main portion |
| 41 | Parting joint |
| 42 | Step |
| 43 | Third seal ring |
| 44 | Bore |
| 45 | Connection surface |
| 46 | Oblique line |
| 47 | Straight line |
| 48 | Lateral surface |
| 49 | Check valve |
| 50 | Spring |
| 51 | Contact surface |
| 52 | Valve body |
| 53 | Valve seat |
| 54 | Sleeve |
| 55 | Spring |
| 56 | Axis of rotation |

What is claimed is:

1. A rolling bearing comprising a first and a second rolling bearing ring mutually concentric to each other and spaced apart from each other by a circumferential gap in which one or more rows of circulating rolling elements are disposed,
wherein said first and second rings each are provided with at least one planar end face with a plurality of coronally arranged fastening bores in each ring capable for connection of the regarding first or second rolling bearing ring to a foundation, or to a chassis, or to an installation part, or to a machine part, and are rotatable relative to each other about a common axis,
and wherein the circumferential gap is sealed at at least one of two mouths by a sealing assembly comprising, at least a first and a second seal ring which are mutually separated from each other,
each of the seal rings comprising at least one sealing lip and an anchoring portion that faces away from said sealing lip,
wherein the seal rings are fixed by said anchoring portions to said first rolling bearing ring, while said at least one sealing lip of the first seal ring bears against a first thrust surface of said second rolling bearing ring, and said at least one sealing lip of the second seal ring bears against a second thrust surface of said second rolling bearing ring,
which first and second thrust surfaces for the at least two mutually separated seal rings are produced together with at least one raceway of said second rolling bearing ring from a first common base body, wherein a cross-sectional shape of the first thrust surface and a cross-sectional shape of the second thrust surface for the sealing lips of the at least two seal rings adjacent to each other are substantially identical,
wherein the anchoring portions of the at least two seal rings adjacent to each other are received in a common depression of said first rolling bearing ring,
and wherein a part of said first rolling bearing ring having the common depression, is a separate portion of said first rolling bearing ring detachable from an annular main portion of the said first rolling bearing ring along a parting joint,
wherein the separate portion carrying the common depression has no raceway, but is fixed to the annular main portion,
which annular main portion is part of the first rolling bearing ring and is provided with at least one raceway produced by machining or shaping of a second common base body from which the annular main portion is made, and wherein the separate portion is a ring with a substantially L-shaped cross section, with
a) a planar free end face of the ring with a substantially L-shaped cross section forming one of the at least one planar connection surfaces of said first rolling bearing ring and being penetrated by coronally distributed bores aligned with respective bores in the annular main portion of said first rolling bearing ring to form the fastening bores capable for securing the first rolling bearing ring to a foundation, or to a chassis, or to an installation part, or to a machine part,
b) and with another end face abutting the annular main portion of said first rolling bearing ring along the parting joint,
c) and further with a circular planar flank that overlaps an end face of one of said seal rings as part of said common depression and has the function of pressing against the overlapped seal ring and thereby pressing at least one of said seal rings firmly against a portion of an end face of the annular main portion of said first rolling bearing ring comprising the raceways for the rolling elements.

2. The rolling bearing as in claim 1, wherein the two adjacent seal rings are separated from each other, within the common depression of the separate portion, by one or more spacers.

3. The rolling bearing as in claim 2, wherein the one or more spacers are configured as a ring or ring segment.

4. The rolling bearing as in claim 1, wherein the common depression of said first rolling bearing ring comprises an indentation, or a groove, or recess.

5. The rolling bearing as in claim 4, wherein the seal consisting of two sealing rings is clamped between a planar portion of the surface of the main ring portion and an indentation of the detachable ring portion, which receives all sealing rings and perhaps one or more spacers axially inserted between both sealing rings.

6. The rolling bearing as in claim 1, wherein the separate portion comprises a different and/or a differently treated material than the annular main portion of said first rolling bearing ring.

7. The rolling bearing as in claim 6, wherein the separate portion, which is detachable from the annular main portion of said first rolling bearing ring, is a ring with a substantially L-shaped cross section whose end face abutting the annular main portion of the said first rolling bearing ring along the parting joint is provided with a smaller area than its planar free end face.

8. The rolling bearing as in claim 1, wherein said sealing lips of the at least two seal rings adjacent to each other bear against said second rolling bearing ring in spaced relation.

9. The rolling bearing as in claim 1, wherein at least one conduit opens between two adjacent seal rings into the common depression, or between the two thrust surfaces for said sealing said lips.

10. The rolling bearing as in claim 9, wherein the at least one conduit extends up to a mouth thereof in an outer surface area of the bearing, namely to a lateral surface thereof or to a planar end face thereof.

11. The rolling bearing as in claim 9, wherein the at least one conduit or at least a branch thereof extends to an inner region of the gap sealed by both sealing rings.

12. The rolling bearing as in claim 11, wherein the at least one conduit or the at least one branch thereof comprises a check valve which prevents lubricant from entering the conduit or branch thereof from the end at the inner region of the gap sealed by both sealing rings.

13. The rolling bearing as in claim 1, wherein the at least two seal rings of the sealing assembly are mounted such that an internal overpressure at end faces of the at least two seal rings facing the rolling elements presses each of the sealing lips additionally against a respective one of the thrust surfaces.

14. The rolling bearing as in claim 13, wherein at least two of said seal rings of the common gap seal each comprise a cross section with a first incut that opens in the direction of the rolling elements.

15. The rolling bearing as in claim 13, wherein said sealing lip of one or more of said mutually separated seal rings is disposed at a free edge of a collar-shaped, and/or conical portion, of the seal ring.

16. The rolling bearing as in claim 15, wherein at least one of said seal rings is mounted such that, beyond and outside the seal lip, a cross-section of the collar-shaped portion diverges from that thrust surface starting at the seal lip, which bears against the thrust surface, to the base part of the collar-shaped portion where it merges with the anchoring portion of the regarding seal ring.

17. The rolling bearing as in claim 16, wherein the collar-shaped portion of at least one of said seal rings is connected to said anchoring portion at an end face of said anchoring portion at an outer side of said seal ring.

18. The rolling bearing as in claim 1, wherein the two seal rings of the common gap seal each comprise a fully circumferential tension wire, or a fully circumferential tension spring, in order to press the sealing lip firmly against the thrust surface.

19. The rolling bearing as in claim 18, wherein both fully circumferential tension wires, or both fully circumferential tension springs, each have a circumferential length that is equal to or greater than the diameter of a rolling element, multiplied by the number of rolling elements in a particular row.

20. The rolling bearing as in claim 1, wherein the two seal rings of the common gap seal are provided with identical cross sections.

21. The rolling bearing as in claim 20, wherein the cross-sectional shapes of the first and second thrust surfaces for the sealing lips of adjacent seal rings are in mutual axial alignment.

22. The rolling bearing as in claim 21, wherein the first and second thrust surfaces, against which sealing lips of the at least two adjacent seal rings bear, or thrust, are part of a common thrust surface having a constant diameter.

23. A rolling bearing assembly, the assembly comprising a first and a second rolling bearing ring concentric to each other, and spaced apart from each other by a circumferential gap in which one or more rows of circulating rolling elements are disposed, wherein said first and second rings each are provided with at least one planar end face with a plurality of coronally arranged fastening bores in each ring capable for connection of the regarding first or second rolling bearing ring to a foundation, or to a chassis, or to an installation part, or to a machine part, and are rotatable relative to each other about a common axis, and wherein the circumferential gap is sealed at at least one of two mouths by a sealing assembly comprising at least two mutually separated seal rings, each of the seal rings comprising at least one sealing lip and an anchoring portion facing away from said sealing lip, wherein the seal rings are fixed by said anchoring portions to said first rolling bearing ring, while said at least one sealing lip of the first seal ring bears against a first thrust surface of said second rolling bearing ring, and said at least one sealing lip of the second seal ring bears against a second thrust surface of said second rolling bearing ring, which first and second thrust surfaces for the at least two mutually separated seal rings are produced together with at least one raceway of said second rolling bearing ring from a first common base body, wherein the cross-sectional shape of the first thrust surface and the cross-sectional shape of the second thrust surface are substantially identical, wherein the anchoring portions of the at least two seal rings adjacent to each other are received in a common depression of said first rolling bearing ring, and wherein a part of said first rolling bearing ring provided with the common depression, is a separate portion of said first rolling bearing ring detachable from an annular main portion of the said first rolling bearing ring, wherein the separate portion carrying the common depression has no raceway, but is fixed to the annular main portion, which annular main portion is part of the first rolling bearing ring, and is provided with at least one raceway produced by machining, or shaping, of a second common base body from which the annular main portion is made, and
wherein the two adjacent seal rings are separated from each other, within the common depression of the receiving portion, by one or more spacers, so that the two sealing rings are spaced from each other and a chamber is formed therebetween,
wherein a surface region located between said first and second thrust surfaces is produced together with at least one raceway of said second rolling bearing ring from a first common base body and comprises at least one opening to a conduit which is routed to an inner region of the circumferential gap and is open thereinto, to route lubricant leaked from the circumferential gap into said chamber back into the circumferential gap, and
wherein the separate portion is a ring with a substantially L-shaped cross section with
a) a planar free end face of the ring with a substantially L-shaped cross section forming one of the at least one planar connection surfaces of said first rolling bearing ring and being penetrated by coronally distributed bores which are aligned with respective bores in the annular main portion of said first rolling bearing ring to form the fastening bores capable for securing the first rolling bearing ring to a foundation, or to a chassis, or to an installation part, or to a machine part,
b) and with another end face abutting the annular main portion of the said first rolling bearing ring along the parting joint,
c) and further with a circular planar flank that overlaps an end face of one of said seal rings as part of said common depression and has the function of pressing against the overlapped seal ring and thereby pressing at least one of said seal rings firmly against a portion of an end face of the annular main portion of the said first rolling bearing ring comprising the raceways for the rolling elements.
